(19) United States
(12) Patent Application Publication
(10) Pub. No.: US 2017/0368647 A1
(43) Pub. Date: Dec. 28, 2017

(54) METHODS FOR REPAIRING FILM HOLES IN A SURFACE

(71) Applicant: General Electric Company, Schenectady, NY (US)

(72) Inventor: Ronald Scott Bunker, West Chester, OH (US)

(21) Appl. No.: 15/191,951

(22) Filed: Jun. 24, 2016

(51) Int. Cl. B23P 6/00; B23P 6/04; F01D 5/00; F01D 5/28; B33Y 10/00; B33Y 80/00; F01D 9/02; F04D 29/32; F04D 29/38; F04D 29/54; F23R 3/00

(52) U.S. Cl. CPC B23P 6/007; B33Y 80/00; B23P 6/045; F01D 5/005; F01D 5/28; F01D 9/02; B33Y 10/00; F04D 29/38; F04D 29/542; F05D 2220/32; F05D 2230/80; F05D 2240/35; F23R 3/002; F04D 29/324

(57) ABSTRACT

Methods for repairing an airfoil having a damaged region are provided. The method can include removing the damaged portion from the airfoil to form an intermediate component. The damaged portion generally includes an original film hole having an original cross-sectional geometry. Using additive manufacturing, a replacement portion is then applied on the intermediate component to form a repaired component with the replacement portion including a rebuilt film hole having a rebuilt cross-sectional geometry that is different than the original cross-sectional geometry.

### FIELD OF THE INVENTION

The present invention generally relates to methods for repairing film holes in a surface of a component of an engine and, more particularly, to methods of converting the exit geometry of the original film hole on the surface to a new geometric not present in the original component.

### BACKGROUND OF THE INVENTION

In order to increase the efficiency and the performance of gas turbine engines so as to provide increased thrust-to-weight ratios, lower emissions and improved specific fuel consumption, turbine engines are tasked to operate at higher temperatures. The components operating within the hot gas sections of the gas turbine engines are subjected to oxidation and thermo-mechanical fatigue amongst other life reducing causes, resulting in repair needs and issues. Typically, components that are damaged beyond repair are replaced with a new component, thereby increasing down-time and costs.

Various components within the gas turbine engine, including certain stator vanes (e.g., turbine nozzles) and rotor blades (e.g., turbine blades), are film cooled across certain areas of the component. Even still, areas of the component can be damaged over time forming distressed areas on the component over time during use. However, the replacement component, in operation, would be subjected to the same fate after its use in the engine. Thus, additional repair and replacement would be required.

Accordingly, it is desirable to provide improved repair methods for turbine components that enable improved cycle times and reduced costs without sacrificing component performance or durability.

### BRIEF DESCRIPTION OF THE INVENTION

Objects and advantages of the invention will be set forth in part in the following description, or may be obvious from the description, or may be learned through practice of the invention.

Methods are generally provided for repairing an airfoil having a damaged region. In one embodiment, the method includes removing the damaged portion from the airfoil to form an intermediate component. The damaged portion generally includes an original film hole having an original cross-sectional geometry. Using additive manufacturing, a replacement portion is applied on the intermediate component to form a repaired component with the replacement portion including a rebuilt film hole having a rebuilt cross-sectional geometry that is different than the original cross-sectional geometry.

Other features and aspects of the present invention are discussed in greater detail below.

### BRIEF DESCRIPTION OF THE DRAWINGS

The invention may be best understood by reference to the following description taken in conjunction with the accompanying drawing figures in which:

FIG. 1A is a perspective view of an exemplary component having a damaged region, such as a turbine blade of a gas turbine engine;

FIG. 1B is a cross-sectional view of a portion of a damaged region, such as of the exemplary component of FIG. 1A, showing the original cross-sectional geometry of the original film holes;

FIG. 2 is a perspective view of an intermediate component formed by removing the damaged region from the component of FIG. 1A;

FIG. 3 is a perspective view of the repaired component after applying, using additive manufacturing, a replacement portion onto the intermediate component of FIG. 2; and

FIG. 4A is a cross-sectional view of a portion of the replacement portion of the exemplary component of FIG. 3 showing one embodiment of the rebuilt cross-sectional geometry of the rebuilt film holes;

FIG. 4B is a cross-sectional view of a portion of the replacement portion of the exemplary component of FIG. 3 showing another embodiment of the rebuilt cross-sectional geometry of the rebuilt film holes; and

FIG. 5 is a diagram showing an exemplary method of repairing a damaged portion of a component.

Repeat use of reference characters in the present specification and drawings is intended to represent the same or analogous features or elements of the present invention.

### DETAILED DESCRIPTION OF THE INVENTION

Reference now will be made to the embodiments of the invention, one or more examples of which are set forth below. Each example is provided by way of an explanation of the invention, not as a limitation of the invention. In fact, it will be apparent to those skilled in the art that various modifications and variations can be made in the invention without departing from the scope or spirit of the invention. For instance, features illustrated or described as one embodiment can be used on another embodiment to yield still a further embodiment. Thus, it is intended that the present invention cover such modifications and variations as come within the scope of the appended claims and their equivalents. It is to be understood by one of ordinary skill in the art that the present discussion is a description of exemplary embodiments only, and is not intended as limiting the broader aspects of the present invention, which broader aspects are embodied exemplary constructions.

As used herein, the terms “first”, “second”, and “third” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

Methods are generally provided for repairing a component having a damaged region, particularly for a component of an engine (e.g., a gas turbine engine). In one embodiment, a damaged portion of the component is first removed to form an intermediate component, and then repaired using additive manufacturing to form a replacement portion on the intermediate component. The replacement portion has a geometry that includes at least one film hole having a different cross-sectional geometry than in the original damaged geometry (previously removed), with the film holes being fluidly connected to a cooling supply of the repaired component. As such, the component can be repaired to include film holes with improved geometries and/or not even present in the original component in order to serve as a corrective action to relieve the causation of the original damaged region. Generally, the repaired portion is formed via additive manufacturing to include the film hole(s) without any additional drilling or other hole forming operation due to the layer by layer formation additive manufacturing process.

In one particular embodiment, the methods can be directed to convert round “showerhead” film holes on a leading edge of an airfoil to a conical film hole. In certain locations, such as on the leading edge of the airfoil, conical shaped film holes have been shown to provide higher film and cooling effectiveness. Conical showerhead holes also involve less solid material volumetrically for a round film hole of the same metering diameter, adding weight savings to the component. As an alternative embodiment, the rebuilt geometry can form leading edge trenches into which the round or otherwise shaped holes exit. Trenches could be curved bottom or rectangular cross section.

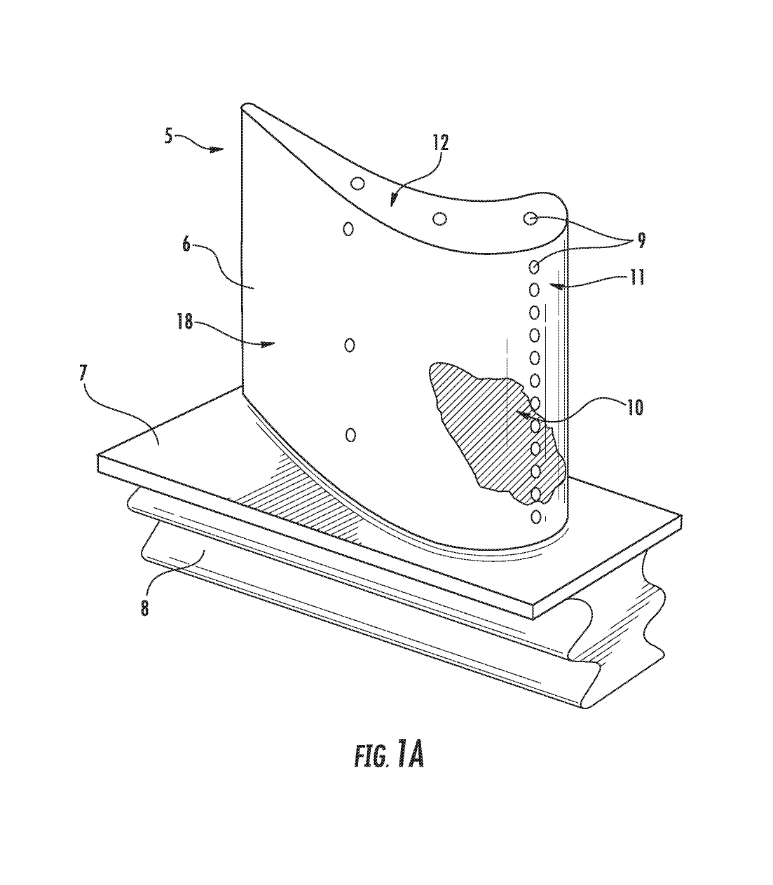

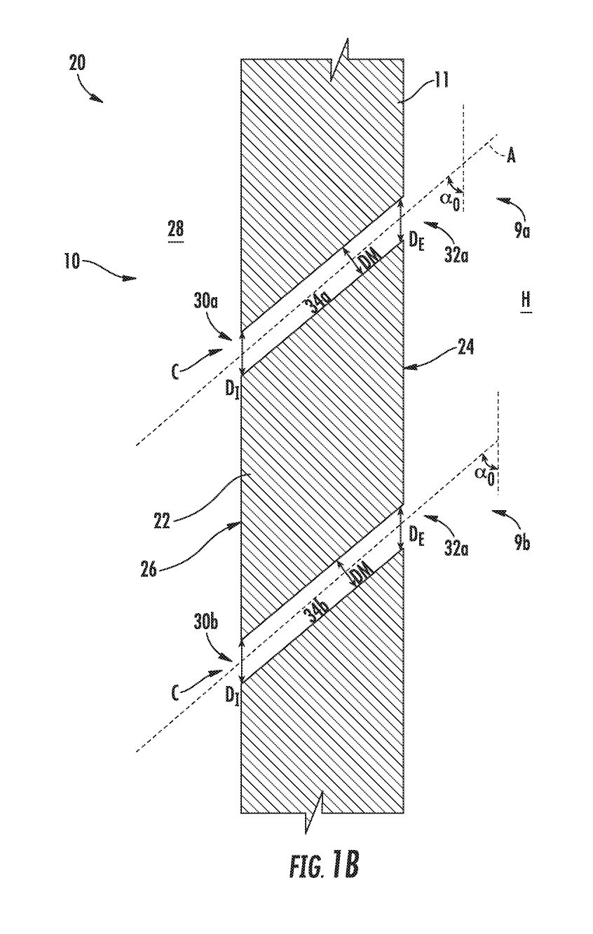

Referring to the drawings, FIG. 1A depicts an exemplary component 5 of a gas turbine engine, illustrated as a gas turbine blade. The turbine blade 5 includes an airfoil 6, a laterally extending platform 7, and an attachment 8 in the form of a dovetail to attach the gas turbine blade 5 to a turbine disk. In some components, a number of cooling channels extend through the interior of the airfoil 6, ending in openings 9 in the surface of the airfoil 6. The openings 9 may be, in particular embodiments, film holes.

After use, the component 5 of FIG. 1A can form a damaged region 10. The damaged region 10 is shown on a portion of the leading edge 11 of the blade 5 and along the pressure and suction sides of the blade 5. Although shown on the leading edge 11 of the blade 5 as an example of the location, the damaged portion 10 can be on any location of the component 5 (e.g., on the trailing edge, the pressure side, the suction side, the tip 12, etc.). In one embodiment, the damaged portion 10 corresponds to a distressed section of the blade 6, such as a burned portion that has degraded over time during use, an abraded and/or dented portion that has lost its original shape, a missing portion that lost material on its surface, etc.

In one embodiment, the airfoil 6 of the turbine blade 5 of FIG. 1A are located in the turbine section of the engine and are subjected to the hot combustion gases from the engine's combustor. In addition to the forced air cooling techniques (e.g., via film holes 9), the surfaces of these components are protected by a coating system 18 on the surface of the blade 5.

The airfoil 6 of the turbine blade 5 of FIG. 1 can be formed of a material that can be formed to the desired shape and generally withstand the necessary operating loads at the intended operating temperatures of the area of the gas turbine in which the segment will be installed. Examples of such materials include metal alloys that include, but are not limited to, titanium-, aluminum-, cobalt-, nickel-, and steel-based alloys. In one particular embodiment, the airfoil 6 of FIG. 1 are formed from a superalloy metal material, such as a nickel-based superalloy, a cobalt-based superalloy, or an iron-based superalloy. In typical embodiments, the superalloy component has a 2-phase structure of fine γ-(M) (face-center cubic) and β-(M)Al (body-center cubic). The β-(M)Al phase is the aluminum (Al) reservoir. Aluminum near the surface may be depleted during service by diffusion to the TBC interface forming α-Al₂O₃ thermally grown oxide on the surface of the diffusion coated substrate.

FIG. 1B shows a close-up, cross-sectional view of a portion 20 of the damaged region 10 of the exemplary component of FIG. 1A showing the original cross-sectional geometry of the original film holes 9 (shown as first original film hole 9A, and second original film hole 9B in FIG. 1B). A cooling fluid flow, represented by arrow C, may be supplied to cool the engine component.

The damaged region 10 includes a substrate 22 having a hot surface 24 (e.g., the outer surface 18 of the airfoil of FIG. 1A) facing the hot combustion gas flow H and a cooling surface 26 facing the cooling fluid C. The substrate 22 may form a wall (exterior wall or inner wall) of the damaged region 10. In the case of a gas turbine engine, the hot surface 24 may be exposed to gases having temperatures in the range of 1000° C. to 2000° C. Suitable materials for the substrate 22 include, but are not limited to, steel, refractory metals such as titanium, or superalloys based on nickel, cobalt, or iron, and ceramic matrix composites. The superalloys can include those in equi-axed, directionally solidified, and single crystal structures.

Each film hole 9A, 9B extends through the component 22 from an inlet 30a, 30b defined in the cooling surface 26 to an outlet 32a, 32b defined in the hot surface 24, respectively. A channel 34a, 34b fluidly connects the inlet 30a, 30b to the outlet 32a, 32b through the component 22. Generally, the film holes 9A, 9B are the original film holes in the component 22, and define an original cross-sectional geometry that includes the shapes and sizes of the inlet 30a, 30b, the channel 34a, 34b, and the outlet 32a, 32b. In one embodiment, the inlet 30a, 30b is a circular aperture with an original inlet diameter D_{I} defined within the cooling surface 26, and the outlet 32a, 32b is a circular aperture with an exit diameter D_{E} defined within the hot surface 24. In such an embodiment, the channel 34a, 34b has, in one embodiment, a conical cross-section extending from the inlet 30a, 30b to the outlet 32a, 32b. A metering diameter (Dₘ) extends across the smallest diameter of the channel 34a, 34b, which in the case of the embodiment of FIG. 1B is substantially constant through the channel 34a, 34b. As shown, the film holes 9A, 9B define an centerline axis A through the channels 34a, 34b. Each film hole 9A, 9B typically has the smallest angle αₒ achievable between the centerline axis A and the tangent of the hot surface 34 at the respective outlet 32a, 32b. It is noted that round holes are always substantially round with effective diameters, since the common drilling methods for initial/original geometry holes currently seldom actually achieves a truly round cross section, or a constant diameter along the length. The diameter is always measured in the cross section perpendicular to the hole centerline axis.

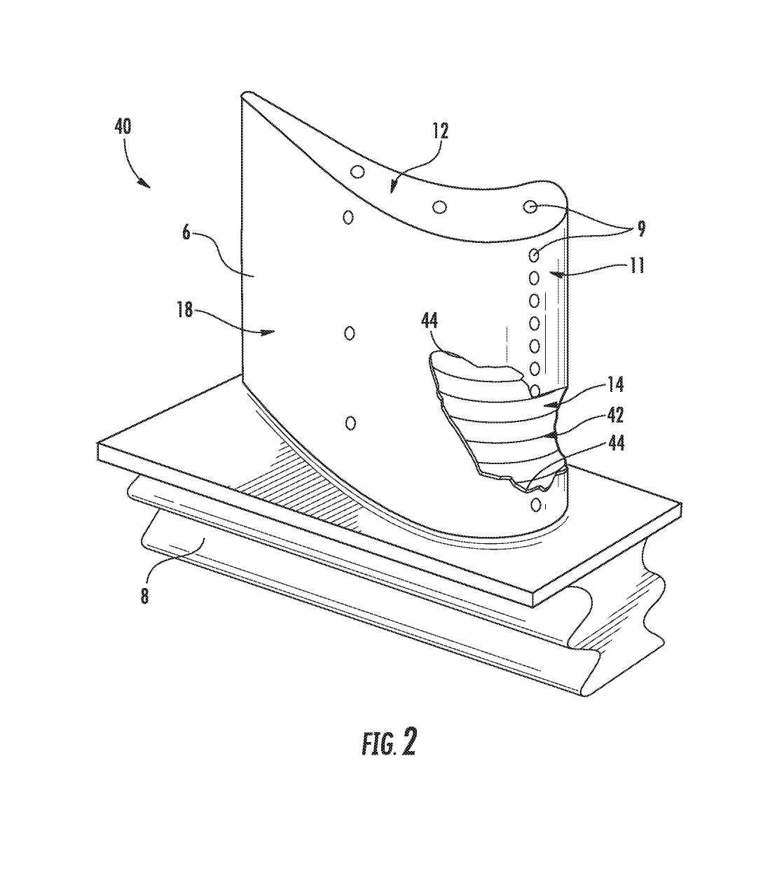

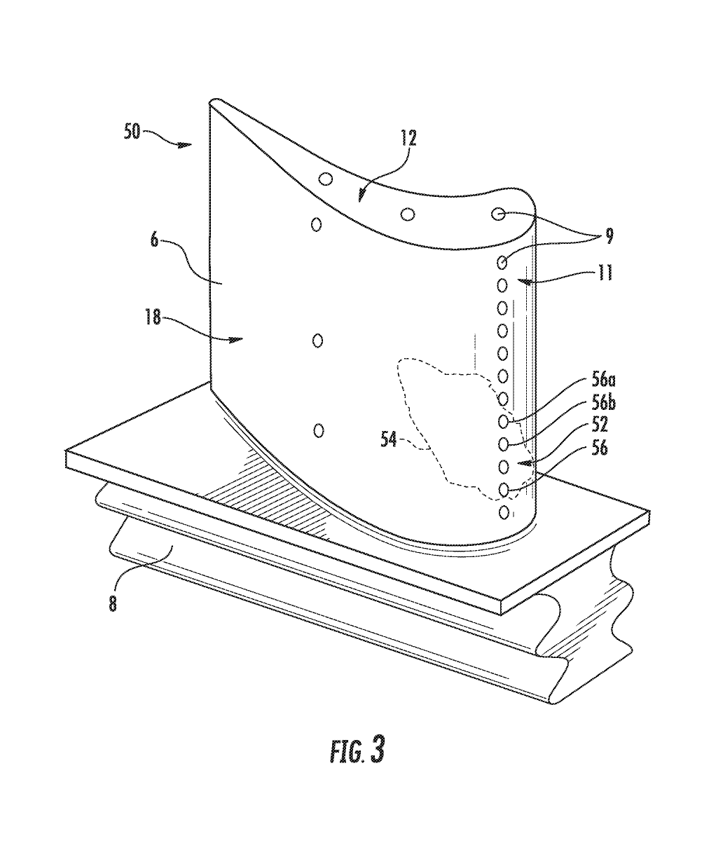

Referring to FIG. 2, an intermediate component 40 is shown based on the blade 5 of FIG. 1A with the damaged portion 10 removed to define a cavity 42. The cavity 42 is at least as big as the damaged portion 10 on the component 5 of FIG. 1A. In certain embodiments, the removed portion cavity 42 may be slightly larger in volume than the damaged portion 10 (e.g., greater than about 105%, or greater than about 110% of the volume of the damaged portion 10). As such, it can be ensured that the entire damaged portion 10 can be removed to form the intermediate component 40. For example, other material can be removed in order to result in the intermediate component 40 having known dimensions, particularly having known dimensions defining the cavity 42. For example, the intermediate component 40 can have a predetermined size and location from which the repaired component 50 of FIG. 3 can subsequently be rebuilt. The predetermined size may be determined based on considerations such as the extent of the damaged portion 10 and/or the structure of the interior cooling passages 14.

In one embodiment, the damaged portion 10 of the component 5 is cleaned prior to removing the damaged portion 10 in order to first remove any coatings or other external layers present on the outer surface 18. For example, thermal barrier coatings (TBC) may be removed from external surface 18 of the damaged portion 10.

In particular embodiments, removal of the damaged portion 10 can be achieved by machining the component 5 around the damaged portion 10 to result in the intermediate component 40 of FIG. 2. Then, the surfaces 44 defining the cavity 42 can be prepared for subsequent application of a replacement portion 52, as shown in FIG. 3. That is, the surfaces 44 of the cavity 42 may undergo grit blasting, water blasting, and further cleaning to remove debris and oxides from the cavity surfaces 44.

Referring to FIG. 3, a repaired component 50 is shown formed from the intermediate component 40 of FIG. 2 with a replacement portion 52 applied within the space where the cavity was located. The replacement portion 52 is bonded, in this example, to the surface 44 of the cavity at the braze 54, although it is not visibly detectable in many embodiments.

Generally, the replacement portion 52 includes at least one rebuilt film hole 56 having a rebuilt cross-sectional geometry that is different than the original cross-sectional geometry of the original film holes 9 (e.g., of FIG. 1A and 1B). That is, at least one of the inlet shape, inlet diameter, metering diameter, channel cross-sectional geometry, outlet shape, and/or outlet diameter of the rebuilt film hole 56 is different than the original film hole 9. For example, the replacement portion 52 is, in one embodiment, substantially identical in shape to the damaged portion 10 but for the rebuilt cross-sectional geometry of the rebuilt film holes 56 compared to the original cross-sectional geometry of the original film holes 9.

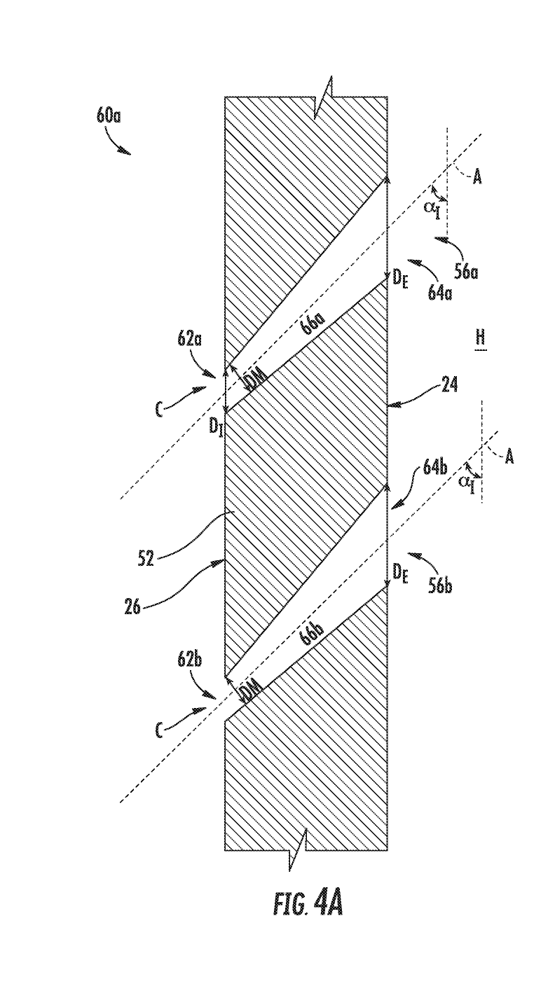

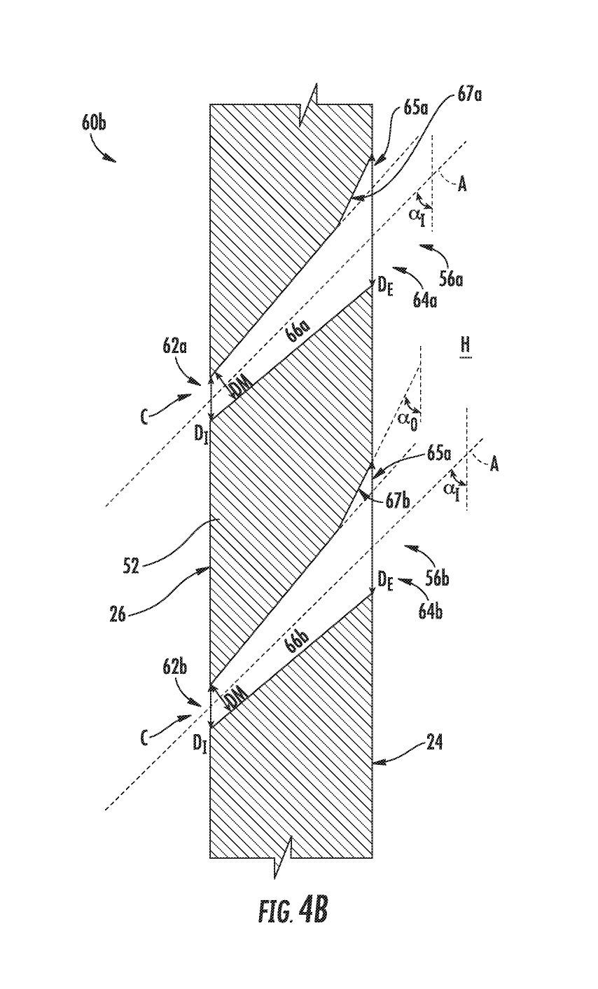

Referring to FIGS. 4A and 4B, exemplary embodiments are shown of a portion 60a, 60b of the replacement portion 52 is shown having rebuilt film hole 56a, 56b defined therein. Each of the rebuilt film holes 56a, 56b includes a respective inlet 62a, 62b having a rebuilt inlet diameter D_{I} and defined in the cooling surface 26, a respective outlet 64a, 64b having a rebuilt exit diameter D_{E} and defined in the hot surface 24, and a respective channel 66a, 66b extending from the inlet 62a, 62b to the outlet 64a, 64b and having a metering diameter D_{M}. In both embodiments of FIGS. 4A and 4B, the rebuilt exit diameter D_{E} is greater in size than the rebuilt inlet diameter D_{I}. Similarly, the rebuilt film holes 56a, 56b have an exit diameter D_{E} of outlets 64a, 64b that is greater than the respective metering diameter D_{M}.

For example, the rebuilt film holes 56a, 56b shown in the embodiment of FIG. 4A include a channel 66a, 66b having a conical cross-section. That is, the diameter of the channel 66a, 66b expands continuously through the channel 66a, 66b from rebuilt inlet diameter D_{I} at the inlet 62a, 62b to the exit diameter D_{E} at the outlet 64a, 64b.

As shown, the rebuilt film holes 56a, 56b define a centerline axis A through the channels 66a, 66b. Each film hole rebuilt film holes 56a, 56b typically has the smallest achievable angle α_{I} between the centerline axis A and the tangent of the hot surface 34 at the respective outlet 64a, 64b. In one particular embodiment, the rebuilt angle α_{I} of the rebuilt film holes 56a, 56b is smaller than the original smallest angle αₒ of the original film holes 9A, 9B (FIG. 1B).

In one embodiment, as shown in the FIG. 4B, the rebuilt film holes 56a, 56b include a diffuser section 65a, 65b in which the cooling fluid C may expand to form a wider cooling film on the hot surface 24. The diffuser section 65a, 65b is generally the downstream-most portion of the channel 66a, 66b with respect to the direction of cooling fluid flow C through the channel 66a, 66b, and is defined at or near the outlet 64a, 64b. As shown in FIG. 4B, the diffuser section 65a, 65b has a diffusion angle α_{D} defined between the diffusion surface 67a, 67b and the centerline axis A at the respective outlet 64a, 64b. In one particular embodiment, the diffusion angle α_{D} of the rebuilt film holes 56a, 56b is smaller than the rebuilt angle α_{I} of the rebuilt film holes 56a, 56b and is smaller than the original smallest angle αₒ of the original film holes 9A, 9B (FIG. 1B).

In one particular embodiment, the exit diameter D_{E} of the outlets 64a, 64b of the rebuilt film holes 56a, 56b (e.g., of the embodiments of FIGS. 4A and 4B) is greater than the original exit diameter D_{E} of the outlets 32a, 32b of the original film holes 9a, 9b of FIG. 1B.

In order to form the repaired component 50, the replacement portion 52 is formed via an additive manufacturing process, either directly onto the intermediate component 40 (e.g., applied layer by layer directly onto the surfaces 44 of the cavity 42) or formed separately from the intermediate component 40 and subsequently bonded onto the surfaces 44 of the cavity 42. In either method, the use of additive manufacturing allows for the replacement portion 52 to including film holes 56 having a geometry that is different than the geometry of the films holes 9 of the original component 5 and/or of the damaged geometry of the damaged portion 10. The film holes 56 are fluidly connected to an internal cavity 14 such that a cooling supply can be directed through the film holes 56 of the replacement portion 52. In one embodiment, the replacement portion 52 can also include at least one film holes 56 absent in the geometry of the original damaged portion 10. In another embodiment, the replacement portion 52 is substantially identical to the geometry of the damaged portion 10 but for the shape of the film holes 56 of the replacement portion 52. Thus, the repaired component 50 can be rebuilt so as to be modified, improved, or otherwise altered from the original design in response to corrective action to relieve the cause that formed the damaged region (e.g., exposure to excess heat). For example, the film holes 56 of the replacement portion 52 can mitigate heat directed at the component 5 in the replacement portion 52, so as to inhibit the cause of the damaged portion 10.

The replacement portion 52 may be formed from a material that has a substantially identical composition than the material of the component 5 (e.g., the same superalloy). Alternatively, the replacement portion 52 may be formed from a material that is different in composition than the material of the component 5 (e.g., different superalloy). However, when using different materials, the coefficient of thermal expansion (CTE) should be tailored to be close to each other to keep the material from spalling during use in the operating conditions of a turbine engine.

In one embodiment, the replacement portion 52 is formed via a direct metal laser fusion process, which is a laser-based rapid prototyping and tooling process utilizing precision melting and solidification of powdered metal into successive layers of larger structures, each layer corresponding to a cross-sectional layer of the 3D component. As known in the art, the direct metal laser fusion system relies upon a design model that may be defined in any suitable manner (e.g., designed with computer aided design (CAD) software). The model may include 3D numeric coordinates of the entire configuration of the component including both external and internal surfaces of an airfoil, platform and dovetail, as well as any internal channels and openings. In one exemplary embodiment, the model may include a number of successive 2D cross-sectional slices that together form the 3D component. Particularly, such a model includes the successive 2D cross-sectional slices corresponding to the turbine component from the machined height. For example, the intermediate component 40 can be imaged to create a digital representation of the intermediate component 40 after removal of the damaged portion 10, and a CAD model can be utilized to form the replacement portion 52 thereon.

Any suitable laser and laser parameters may be used, including considerations with respect to power, laser beam spot size, and scanning velocity. The build material may be formed by any suitable powder, including powdered metals, such as a stainless steel powder, and alloys and super alloy materials, such as nickel-based or cobalt superalloys. In one exemplary embodiment, the build material is a high temperature nickel base super alloy. The powder build material may be selected for enhanced strength, durability, and useful life, particularly at high temperatures. Each successive layer may be, for example, between 10 μm and 200 μm, although the thickness may be selected based on any number of parameters.

As noted above, the repaired component 50 includes internal cooling passages that deliver a cooling flow to the film holes 56. The cooling passages may be relatively complex and intricate for tailoring the use of the limited pressurized cooling air and maximizing the cooling effectiveness thereof and the overall engine efficiency. However, the successive, additive nature of the laser fusion process enables the construction of these passages.

Although the direct metal laser fusion process is described above, other rapid prototyping or additive layer manufacturing processes may be used to apply and form the replacement portion 52, including micro-pen deposition in which liquid media is dispensed with precision at the pen tip and then cured; selective laser sintering in which a laser is used to sinter a powder media in precisely controlled locations; laser wire deposition in which a wire feedstock is melted by a laser and then deposited and solidified in precise locations to build the product; electron beam melting; laser engineered net shaping; direct metal laser sintering; and direct metal deposition. In general, additive repair techniques provide flexibility in free-form fabrication and repair without geometric constraints, fast material processing time, and innovative joining techniques.

Other post processing may be performed on the replacement portion 52, such as stress relief heat treatments, peening, polishing, hot isostatic pressing (HIP), or coatings.

Although described above and in FIGS. 1A, 2, and 3 with respect to the turbine blade 5, the methods of repair can be utilized with any component of the gas turbine engine, such as turbine nozzles (e.g., airfoils of a turbine nozzle or nozzle segment), compressor blades, compressor vanes, combustion liners, turbine shrouds, fan blades, etc.

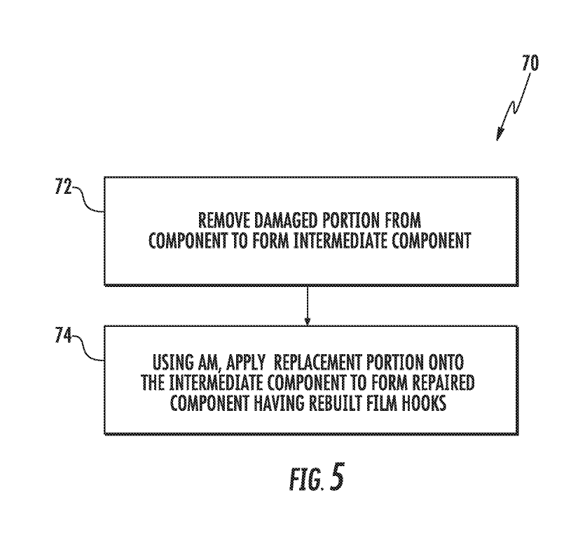

FIG. 5 shows a diagram of an exemplary method 70 of repairing a damaged portion of a component. At 72, a damaged portion is removed from the component to form an intermediate component. The damaged portion includes an original film hole having an original cross-sectional geometry. At 74, using additive manufacturing (AM), a replacement portion is applied onto the intermediate component to form a repaired component that includes a rebuilt film hole having a rebuilt cross-sectional geometry that is different than the original cross-sectional geometry of the original film hole. Generally, the film holes are fluidly connected to a cooling supply of the repaired component.

These and other modifications and variations to the present invention may be practiced by those of ordinary skill in the art, without departing from the spirit and scope of the present invention, which is more particularly set forth in the appended claims. In addition, it should be understood the aspects of the various embodiments may be interchanged both in whole or in part. Furthermore, those of ordinary skill in the art will appreciate that the foregoing description is by way of example only, and is not intended to limit the invention so further described in the appended claims.

What is claimed is:

1. A method of repairing an airfoil having a damaged region, the method comprising:
removing the damaged portion from the airfoil to form an intermediate component, wherein the damaged portion includes an original film hole having an original cross-sectional geometry; and
applying using additive manufacturing a replacement portion on the intermediate component to form a repaired component, wherein the replacement portion includes a rebuilt film hole having a rebuilt cross-sectional geometry that is different than the original cross-sectional geometry.

2. The method of claim 1, wherein the rebuilt cross-sectional geometry includes a channel having a conical cross-section.

3. The method of claim 2, wherein the rebuilt film hole defines an outlet having an exit diameter that is greater than a metering diameter of the rebuilt film hole.

4. The method of claim 2, wherein the original film hole has an original exit diameter, and wherein the rebuilt film hole defines an outlet having an exit diameter that is greater than the original exit diameter.

5. The method of claim 1, wherein the damaged portion includes a plurality of the original film holes having the original cross-sectional geometry.

6. The method of claim 5, wherein the replacement portion includes a plurality of the rebuilt film holes having the rebuilt cross-sectional geometry.

7. The method of claim 1, wherein the rebuilt cross-sectional geometry includes a diffuser section.

8. The method of claim 1, wherein the replacement portion is substantially identical in shape to the damaged portion but for the rebuilt cross-sectional geometry compared to the original cross-sectional geometry.

9. The method of claim 1, wherein the replacement portion includes a plurality of film holes absent in the damaged portion.

10. The method of claim 1, wherein the component comprises an airfoil.

11. The method of claim 10, wherein each film hole is in fluid communication with a cooling supply is internal within the airfoil.

12. The method of claim 11, wherein the damaged portion includes at least a portion of a leading edge of the airfoil.

13. The method of claim 10, wherein the component is a turbine blade with the airfoil extending from a platform to a tip.

14. The method of claim 13, wherein the damaged portion includes a portion of the tip of the turbine blade.

15. The method of claim 10, the component is a turbine nozzle segment with the airfoil extending from an inner band to an outer band.

16. The method of claim 1, wherein the repaired portion is applied directly onto the intermediate component through additive manufacturing.

17. The method of claim 1, wherein applying using additive manufacturing a repaired portion onto the intermediate component to form a repaired component comprises:
forming the repaired portion using additive manufacturing; and
thereafter, bonding the repaired portion onto the intermediate component to form the repaired component.

18. The method of claim 1, further comprising:
imaging the intermediate component to create a digital representation of the intermediate component after removal of the damaged portion.

19. The method of claim 1, wherein the component comprises a first material, and wherein the repaired portion comprises a second material that has a composition that is compatible to the first material.

20. The method of claim 1, wherein the first material and the second material comprise a super-alloy.
